(19) United States
(12) Patent Application Publication
(10) Pub. No.: US 2024/0295997 A1
(43) Pub. Date: Sep. 5, 2024

(54) TERMINAL DEVICE, METHOD FOR CONTROLLING TERMINAL DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Kota NISHIDA, SHIOJIRI-SHI (JP)

(21) Appl. No.: 18/592,612

(22) Filed: Mar. 1, 2024

(30) Foreign Application Priority Data
Mar. 2, 2023 (JP) 2023-031707

(51) Int. Cl. G06F 3/12

(52) U.S. Cl. CPC G06F 3/1226; G06F 3/1204; G06F 3/1236; G06F 3/1254; G06F 3/1286

(57) ABSTRACT

A terminal device includes a connection processor and a printing controller. The connection processor searches for a plurality of printing devices conforming to a NAN standard, and establishes first wireless communication connection with the plurality of printing devices conforming to the NAN standard. The printing controller performs control to distribute and transmit print jobs to the plurality of printing devices using the first wireless communication connection.

The present application is based on, and claims priority from JP Application Serial Number 2023-031707, filed Mar. 2, 2023, the disclosure of which is hereby incorporated by reference herein in its entirety.

### BACKGROUND

### 1. Technical Field

The present disclosure relates to a terminal device, a method of controlling a terminal device, and a non-transitory computer-readable storage medium storing a program.

### 2. Related Art

In Wi-Fi Aware which is one of Wi-Fi Alliance certification programs, a communication protocol called a neighbor awareness network (NAN), which wirelessly communicates between devices without using an access point, is defined. Hereinafter, a standard for the NAN defined by Wi-Fi Alliance is referred to as a NAN standard. JP-A-2019-134322 discloses a technique for implementing printing by transmitting data from a terminal device to a printing device using wireless communication conforming to the NAN standard.

JP-A-2019-134322 is an example of the related art.

### SUMMARY

According to JP-A-2019-134322, a user can perform printing using the printing device in which communication connection conforming to the NAN standard is established. However, in the technique described in this document, since data is transmitted from the terminal device to one printing device for printing, it takes time to complete the printing. Therefore, it is required to shorten a time until the printing is completed.

A terminal device according to the present disclosure includes: a first connection processing unit configured to search for a plurality of printing devices conforming to an NAN standard, and to establish first wireless communication connection with the plurality of printing devices conforming to the NAN standard; and a printing control unit configured to perform control to distribute and transmit a print job to the plurality of printing devices using the first wireless communication connection.

A method for controlling a terminal device according to the present disclosure includes: searching for a plurality of printing devices conforming to a NAN standard, and establishing first wireless communication connection with the plurality of printing devices conforming to the NAN standard; and performing control to distribute and transmit a print job to the plurality of printing devices using the first wireless communication connection.

A non-transitory computer-readable storage medium storing a program according to the present disclosure causes a computer to: execute first connection processing of searching for a plurality of printing devices conforming to an NAN standard, and establishing first wireless communication connection with the plurality of printing devices conforming to the NAN standard; and execute printing control of performing control to distribute and transmit a print job to the plurality of printing devices using the first wireless communication connection.

### BRIEF DESCRIPTION OF THE DRAWINGS

FIG. 1 is a schematic diagram showing an example of a configuration of a printing system according to an embodiment.

FIG. 2 is a block diagram showing an example of a configuration of a terminal device according to the embodiment.

FIG. 3 is a table showing scores for 5 printed sheets, 10 printed sheets, 20 printed sheets, 60 printed sheets, and 100 printed sheets.

FIG. 4 is a block diagram showing an example of a configuration of a printing device according to the embodiment.

FIG. 5 is a flowchart showing an example of an operation flow of the terminal device according to the embodiment.

FIG. 6 is a flowchart showing an example of the operation flow of the terminal device according to the embodiment.

FIG. 7 is a schematic diagram showing an example of a user interface screen displayed by a display control unit.

FIG. 8 is a schematic diagram showing an example of a user interface screen when manual selection is performed.

FIG. 9 is a schematic diagram showing an example of a configuration of a printing system according to a modification of the embodiment.

FIG. 10 is a block diagram of an example of a configuration of a terminal device according to the modification of the embodiment.

FIG. 11 is a block diagram showing an example of a configuration of a printing device according to the modification of the embodiment.

### DESCRIPTION OF EMBODIMENTS

Hereinafter, an embodiment will be described with reference to the drawings. To clarify the description, the following description and drawings are omitted and simplified as appropriate. In the drawings, the same elements are denoted by the same reference signs, and the redundant description thereof is omitted as necessary.

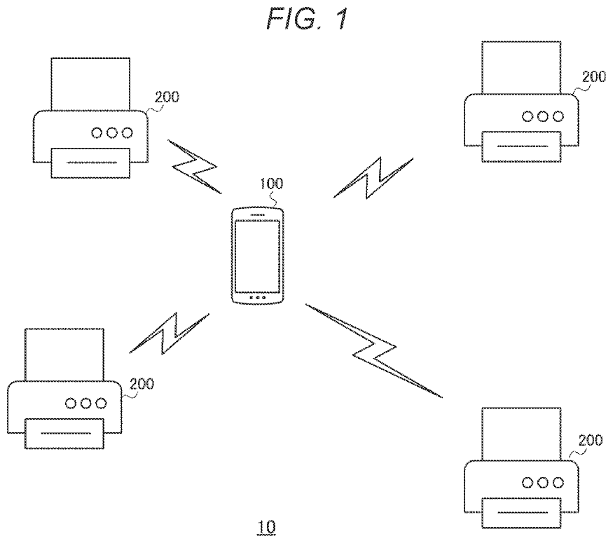

FIG. 1 is a schematic diagram showing an example of a configuration of a printing system 10 according to an embodiment. The printing system 10 includes a terminal device 100 and one or more printing devices 200.

Each printing device 200 is a device having a function of performing printing processing, and is specifically a printer in the embodiment. Each printing device 200 is disposed in, for example, one office, but an installation location of the printing device 200 is not limited thereto.

The terminal device 100 is a terminal device that transmits a print job to the printing device 200. The terminal device 100 is a terminal such as a personal computer (PC), a smartphone, or a tablet terminal operated by a user.

In the printing system 10, the terminal device 100 and the one or more printing devices 200 communicate with each other conforming to a NAN standard. As will be described later, in the embodiment, the terminal device 100 and the one or more printing devices 200 may have already established wireless communication connection or may newly establish wireless communication connection according to a connection sequence defined by the NAN standard. FIG. 1 shows four printing devices 200 as an example, but the number of printing devices 200 that communicate with the terminal device 100 conforming to the NAN standard may be any number.

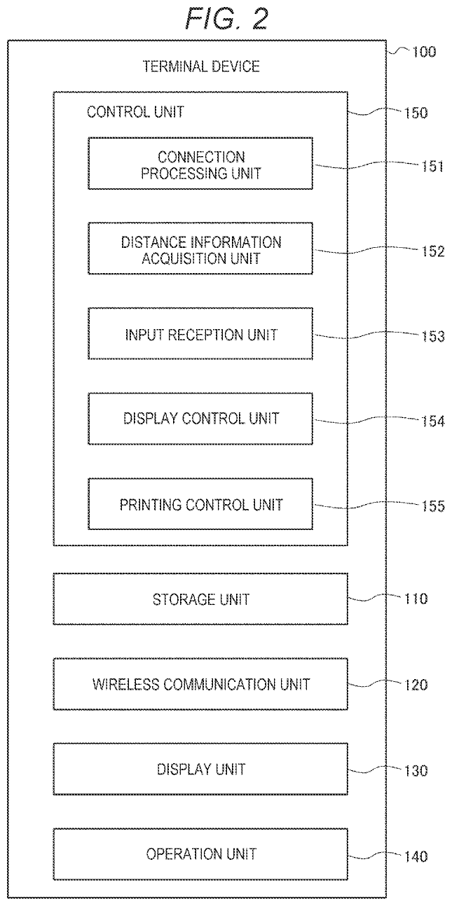

Hereinafter, a specific configuration and processing of the printing system 10 will be described. First, the terminal device 100 will be described. FIG. 2 is a block diagram showing an example of a configuration of the terminal device 100. As shown in FIG. 2, the terminal device 100 includes a storage unit 110, a wireless communication unit 120, a display unit 130, an operation unit 140, and a control unit 150.

The storage unit 110 is a storage device that stores a program for implementing processing of the control unit 150 and data used for processing of the terminal device 100. The storage device may be a nonvolatile storage device such as a hard disk or a flash memory, or may include a memory such as a random access memory (RAM).

The wireless communication unit 120 is hardware that performs wireless communication. That is, the wireless communication unit 120 is a wireless communication interface. The wireless communication unit 120 may include a transmission circuit, a reception circuit, and an antenna.

The display unit 130 and the operation unit 140 are user interfaces. The display unit 130 is implemented by a display or the like that displays various types of information to the user. The operation unit 140 is implemented by a button or the like that receives an input operation from the user. The display unit 130 and the operation unit 140 may be integrally implemented by a touch panel or the like.

The control unit 150 is a processor such as a central processing unit (CPU) that controls each component of the terminal device 100. The control unit 150 may include a plurality of processors. The control unit 150 reads a program into the memory and executes the program. Accordingly, in the embodiment, the control unit 150 implements functions of a connection processing unit 151, a distance information acquisition unit 152, an input reception unit 153, a display control unit 154, and a printing control unit 155.

The connection processing unit 151 searches for the printing device 200 conforming to the NAN standard and establishes the wireless communication connection with the printing device 200 conforming to the NAN standard. In particular, in the embodiment, in order to implement printing using the plurality of printing devices 200, the connection processing unit 151 searches for the plurality of printing devices 200 and establishes the wireless communication connection with the plurality of printing devices 200 conforming to the NAN standard. Hereinafter, the wireless communication connection conforming to the NAN standard is also referred to as NAN connection. Here, in the embodiment, the wireless communication connection conforming to the NAN standard is specifically a NAN data link. Details of processing of the connection processing unit 151 for establishing NAN connection (NAN data link) between the terminal device 100 and the printing device 200 will be described later.

The distance information acquisition unit 152 acquires, for each of the printing devices 200, distance information indicating a distance between the terminal device 100 and the printing device 200 measured conforming to the NAN standard. The NAN standard defines a technique in which a device constituting a NAN cluster described later measures a distance between another device constituting the NAN cluster and the device. The technique is also called Ranging. In Ranging, a predetermined frame is transmitted and received between the devices constituting the NAN cluster, and a distance between the devices is calculated based on a transmission and reception time of the predetermined frame. The distance information acquisition unit 152 acquires the distance between the terminal device 100 and the printing device 200 measured using the technique. The distance information acquisition unit 152 may acquire distance information indicating the distance measured by the terminal device 100 or may acquire, from the printing device 200, information indicating the distance measured by the printing device 200. In the embodiment, the distance information acquisition unit 152 acquires the distance measured conforming to the NAN standard, and may acquire a distance measured according to another technique. In this case, the distance information acquired by the distance information acquisition unit 152 may be information indicating the distance measured by the terminal device 100 or information indicating a distance received from another device. The distance information acquisition unit 152 may acquire the information indicating the distance between the terminal device 100 and the printing device 200 input by the user via the operation unit 140.

The input reception unit 153 receives an instruction or information input by the user via the operation unit 140. In the embodiment, for example, the input reception unit 153 receives an instruction corresponding to a printing operation performed by the user via the operation unit 140. The instruction includes an instruction to designate data to be printed. The instruction may further include an instruction to designate a print setting or an instruction to designate a model or a vendor of the printing device 200 used for printing. Here, the print setting includes, for example, a setting for designating a size of a sheet to be used, a setting for designating whether to perform printing without providing a margin on an edge of a sheet, a setting for designating whether to perform color printing, and a setting for designating whether to perform duplex printing, but is not limited thereto. The input reception unit 153 receives an instruction to designate whether to automatically set or manually set the printing device 200 as a transmission destination of the print job. The input reception unit 153 receives an instruction to select the printing device 200 as the transmission destination when manually setting the printing device 200 as the transmission destination of the print job.

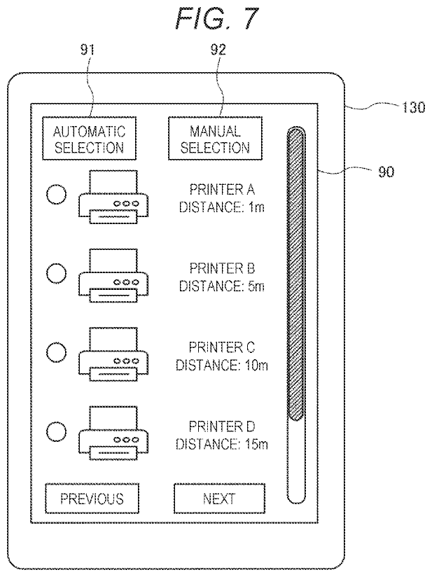

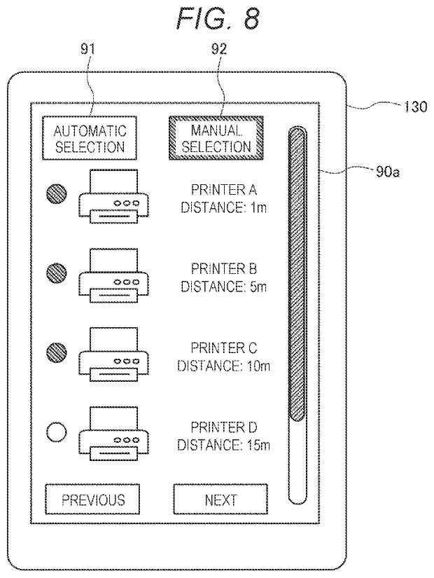

The display control unit 154 controls display performed by the display unit 130. For example, the display control unit 154 displays a user interface screen for receiving a printing operation. The display control unit 154 causes the display unit 130 to display a user interface screen for determining the printing device 200 as the transmission destination of the print job as shown in FIG. 7 or 8 described later. In particular, the display control unit 154 controls the display unit 130 to display the distance information for each printing device 200 acquired by the distance information acquisition unit 152. Accordingly, it is possible to make the user know the burden on the user related to the movement necessary for putting the printed matter into the hand.

The printing control unit 155 performs control processing for causing the printing device 200 to perform printing. The printing control unit 155 generates a print job according to an instruction of the printing operation received by the input reception unit 153. The print job is data necessary for the printing device 200 to perform printing, and includes, for example, image data to be printed and data for designating print conditions. Then, the printing control unit 155 performs control to transmit the print job to the printing device 200 using the wireless communication connection, that is, the NAN connection established by the connection processing unit 151. In particular, the printing control unit 155 performs control to distribute and transmit the generated print job to the plurality of printing devices 200 for which the NAN connection with the terminal device 100 is established.

Prior to the transmission of the print job, the printing device 200 as the transmission destination is determined. In the embodiment, the printing device 200 as the transmission destination is determined by manual selection or automatic selection. In the embodiment, whether to determine the printing device 200 as the transmission destination by the manual selection or determine the printing device 200 as the transmission destination by the automatic selection is determined according to the instruction of the user. However, the manual selection may be normally performed or the automatic selection may be normally performed regardless of the instruction of the user.

The printing device 200 as the transmission destination is determined from among the printing devices 200 capable of performing the printing instructed by the printing operation. When only the printing device 200 that has already been NAN connected to the terminal device 100 at the time of the printing operation of the user is set as a candidate of the transmission destination of the print job, the following processing is performed to find the printing device 200 capable of performing the printing instructed by the printing operation. In this case, the printing control unit 155 acquires, from the one or more printing devices 200 for which the NAN connection is established, information on a service of the printing devices 200 using the NAN connection. Then, based on the information, the printing control unit 155 specifies the printing device 200 capable of performing the printing instructed by the printing operation. Accordingly, in this case, the printing control unit 155 selects the printing device 200 as the transmission destination of the print job based on the information on the service of the printing devices 200 acquired using the NAN connection. The printing control unit 155 inquires of each already connected printing device 200 on the service of the printing devices 200 using the NAN connection. On the other hand, the printing device 200 transmits the information on the service. Here, the information on the service is information related to the service provided by the printing device 200, and may be information indicating whether a printing service can be provided or may be information indicating whether a printing service for printing with a specific print setting can be provided. The information on the service may be information indicating whether a printing service can be provided by a specific model or a vendor. Accordingly, it is possible to acquire an appropriate candidate for selecting the printing device 200 by the manual selection or the automatic selection.

When a new printing device 200 to be NAN connected to the terminal device 100 is searched for after the printing operation of the user, the following processing is performed to find the printing device 200 capable of performing the printing instructed by the printing operation. In this case, the connection processing unit 151 searches for one or more printing devices 200 capable of providing a service satisfying a specific condition by broadcasting an inquiry about a service conforming to the NAN standard. The specific condition is a condition that needs to be satisfied in order to implement the printing instructed by the printing operation. That is, the connection processing unit 151 searches for the printing device 200 capable of providing the printing service. When the instruction of the printing operation includes an instruction to designate a print setting, the connection processing unit 151 searches for the printing device 200 capable of providing a printing service for printing with the designated print setting. When the instruction of the printing operation includes an instruction to designate a model or a vendor of the printing device 200 used for printing, the connection processing unit 151 searches for the printing device 200 capable of providing a printing service for printing by a device having the designated model or vendor. Accordingly, it is possible to acquire an appropriate candidate for selecting the printing device 200 by the manual selection or the automatic selection. When the printing device 200 that satisfies the above-described specific condition is found, the connection processing unit 151 establishes the NAN connection with the printing device 200.

When the manual selection is performed, the printing control unit 155 determines the printing device 200 to which the print job is to be transmitted according to the instruction of the user to select the printing device 200 received by the input reception unit 153. In this case, the display control unit 154 controls the display unit 130 to display a list of candidates of the printing device 200 as the transmission destination. Specifically, the candidates of the printing device 200 as the transmission destination are the printing devices 200 that are NAN connected to the terminal device 100, and are the printing devices 200 capable of performing the printing instructed by the printing operation.

When the automatic selection is performed, the printing control unit 155 selects the printing device 200 from the candidates of the printing device 200 as the transmission destination according to a predetermined selection rule. In particular, when there is a plurality of candidates of the printing device 200 as the transmission destination, the printing control unit 155 may automatically select the plurality of printing devices 200.

In the embodiment, when the automatic selection is performed, the printing control unit 155 selects, based on the distance information acquired by the distance information acquisition unit 152, the printing device 200 to which the print job is to be transmitted. That is, the printing control unit 155 selects the printing devices 200 in order of closeness to a position of the terminal device 100 based on the acquired distance information. Accordingly, it is possible to reduce the burden of the user on the movement.

In the embodiment, as an example, specifically, the printing control unit 155 selects, based on the distance information, the printing device 200 as follows. The printing control unit 155 may calculate, based on the distance between the terminal device 100 and one printing device 200 and the number of printed sheets, a score when printing is performed by m printing devices 200 selected in order of closeness to the terminal device 100. Here, m is any integer from 1 to M, and M is a total number of the printing devices 200 capable of performing the printing instructed by the printing operation, the printing devices 200 being NAN connected to the terminal device 100. The number of printed sheets described above is the number of printed sheets specified based on the instruction of the printing operation. For example, when the user gives an instruction to print Q copies of a document including P pages, the number of printed sheets is P·Q. Specifically, the printing control unit 155 calculates a score Sₘ when printing is performed by m printing devices 200 selected in order of closeness to the terminal device 100, using the following calculation formula.

$${S}_{m} = ( N \cdot T ) / m + ( {t}_{1} + {t}_{2} + … + {t}_{m} )$$

Here, N is the number of printed sheets specified based on the instruction of the printing operation. T is a printing time per sheet. In the embodiment, a predetermined value (specifically, 3 seconds) is used as the value of T. Tᵢ (where i=1, 2, . . . , m) is a time required for the user to move a distance from the terminal device 100 to the printing device 200 in i-th proximity to the terminal device 100. For example, tᵢ is calculated based on the distance from the terminal device 100 to the printing device 200 in i-th proximity to the terminal device 100 and a predetermined movement speed (specifically, 1 meter per second) of the user.

For example, it is assumed that there are a printer A, a printer B, a printer C, and a printer D as the printing devices 200 capable of performing the printing instructed by the printing operation, and distances from the printer A, the printer B, the printer C, and the printer D to the terminal device 100 are as follows.

The distance between the terminal device 100 and the printer A: 1 meter

The distance between the terminal device 100 and the printer B: 5 meters

The distance between the terminal device 100 and the printer C: 10 meters

The distance between the terminal device 100 and the printer D: 15 meters

In this case, a score S₃ when 5 sheets are printed by three printing devices 200 (that is, the printers A, B, and C) selected in order of closeness to the terminal device 100 is calculated as follows. Here, T=3, and the movement speed of the user is calculated as 1 meter per second.

$${S}_{3} = ( 5 \cdot 3 ) / 3 + ( 1 + 5 + 10 ) = 21$$

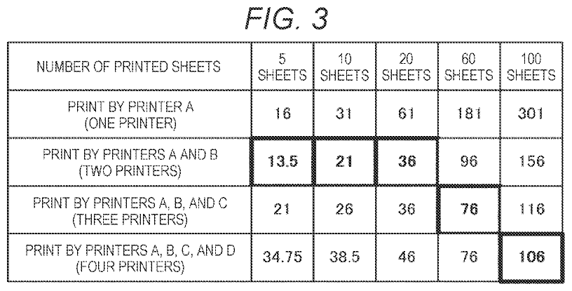

FIG. 3 is a table showing scores for 5 printed sheets, 10 printed sheets, 20 printed sheets, 60 printed sheets, and 100 printed sheets in the example described above. As is clear from the definition of the score described above, the calculated score represents a time cost. Therefore, a smaller score value means a more efficient work. Accordingly, with reference to FIG. 3, when the number of printed sheets is 5, 10, and 20, the printing control unit 155 automatically selects the two printers A and B as the printing devices 200 as the transmission destination of the print job. When the number of printed sheets is 60, the printing control unit 155 automatically selects the three printers A, B, and C as the printing devices 200 as the transmission destination of the print job. When the number of printed sheets is 100, the printing control unit 155 automatically selects the four printers A, B, C, and D as the printing devices 200 as the transmission destination of the print job.

The specific example of the automatic selection of the printing device 200 based on the distance information is described above. Alternatively, the printing control unit 155 may implement the automatic selection of the printing device 200 based on the distance information by another algorithm. In particular, in the specific example described above, in order to simplify the processing, the automatic selection of the printing device 200 is performed using only the distance between the terminal device 100 and the printing device 200. However, the printing control unit 155 may further use distance information indicating a distance between the printing devices 200 to estimate a movement distance of the user more accurately, and then perform the automatic selection. In this case, for example, the distance information acquisition unit 152 may acquire information indicating a distance to another printing device 200 from one printing device 200. In this case, for example, each printing device 200 transmits, to the terminal device 100, a distance between the printing device 200 and another printing device 200 measured conforming to the NAN standard, and may transmit a distance measured according to another technique.

When the printing device 200 to which the print job is to be transmitted is determined by the manual selection or the automatic selection, the printing control unit 155 generates a print job for printing that the printing device 200 is in charge of for each printing device 200 as the transmission destination of the print job. When there is the plurality of printing devices 200 selected as transmission destinations, the print job assigned to each printing device 200 is a print job in charge of a part of printing instructed by a printing operation. That is, when the printing processing is performed for all the print jobs assigned to the printing devices 200, all the printing instructed by the printing operation is implemented.

Specifically, the printing control unit 155 generates, for each printing device 200, a print job that the printing device 200 as the transmission destination is in charge of, based on the number of printed sheets specified based on the instruction of the printing operation and a total number of the printing devices 200 as the transmission destinations. For example, when the number of printed sheets specified based on the instruction of the printing operation is N and the number of printing devices 200 as the transmission destinations is m, the printing control unit 155 generates a print job such that the printing of the N sheets is performed by the m printing devices 200. For example, when the user gives an instruction to print Q copies of a document including P pages, the printing control unit 155 generates a print job such that the printing of P·Q sheets is performed by the m printing devices 200. Then, the printing control unit 155 performs control to transmit each print job to the printing device 200 in charge of the print job. For example, a case is considered in which a total of 5 sheets are printed by three printing devices 200. In this case, for example, the printing control unit 155 generates a first print job for printing two sheets on a first printing device 200, generates a second print job for printing two sheets on a second printing device 200, and generates a third print job for printing one sheet on a third printing device 200. Then, the printing control unit 155 transmits the first print job to the first printing device 200, transmits the second print job to the second printing device 200, and transmits the third print job to the third printing device 200 using the NAN connection. When a plurality of copies of a document including P pages are printed (that is, when Q>1), the printing control unit 155 may cause each printing device 200 to perform printing in units of copies. That is, in this case, the printing control unit 155 may perform control to generate print jobs and transmit each print job such that one document is not separately printed by different printing devices 200, in other words, one document is printed by the same printing device 200.

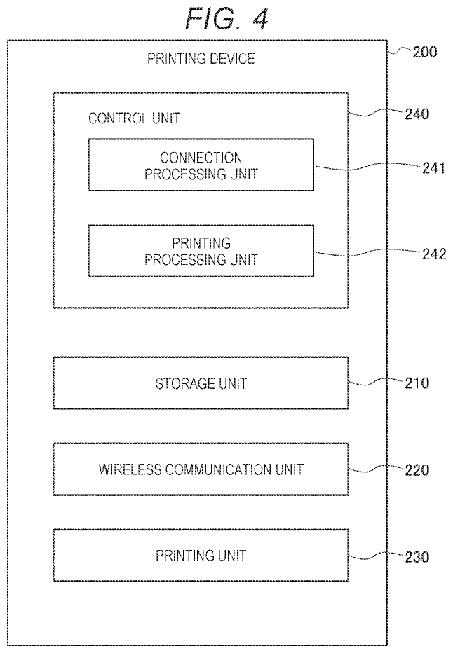

Next, the printing device 200 will be described. FIG. 4 is a block diagram showing an example of a configuration of the printing device 200. As shown in FIG. 4, the printing device 200 includes a storage unit 210, a wireless communication unit 220, a printing unit 230, and a control unit 240. The printing device 200 may further include a user interface such as a touch panel display.

The storage unit 210 is a storage device that stores a program for implementing processing of the control unit 240 and data used for processing of the printing device 200. The storage device may be a nonvolatile storage device such as a hard disk or a flash memory, and may include a memory such as a RAM.

The wireless communication unit 220 is hardware that performs wireless communication. That is, the wireless communication unit 220 is a wireless communication interface. The wireless communication unit 220 may include a transmission circuit, a reception circuit, and an antenna.

The printing unit 230 has a printing function for printing on a printing medium such as a sheet. The printing unit 230 includes a printing engine. The printing engine is a mechanical configuration that prints an image on the printing medium using a color material. The printing engine may include a mechanism for printing using ink by, for example, an inkjet method. Alternatively, the printing engine may include a mechanism for printing using toner by, for example, electrophotography. The printing engine may include a transport mechanism for transporting the printing medium.

The control unit 240 is a processor such as a CPU that controls each component of the printing device 200. The control unit 240 may include a plurality of processors. The control unit 240 reads a program into the memory and executes the program. Accordingly, in the embodiment, the control unit 240 implements functions of a connection processing unit 241 and a printing processing unit 242.

The connection processing unit 241 performs processing of establishing the NAN connection with the terminal device 100. Details of processing of the connection processing unit 241 for establishing the NAN connection between the terminal device 100 and the printing device 200 will be described later. When an inquiry about the service of the printing device 200 is received from the terminal device 100 with which the NAN connection is established, the connection processing unit 241 transmits information on the service provided by the printing device 200.

The printing processing unit 242 performs processing for performing printing by the printing unit 230. In the embodiment, the printing processing unit 242 performs, using the printing unit 230, printing according to a print job received from the terminal device 100.

Next, details of processing of the connection processing unit 151 and the connection processing unit 241 for establishing the NAN connection between the terminal device 100 and the printing device 200 will be described. In order to establish the NAN connection, first, the terminal device 100 and the printing device 200 constitute a NAN cluster. Thereafter, the terminal device 100 and the printing device 200 establish the NAN connection, that is, a NAN data link.

In the NAN standard, a period called a discovery window (DW) is defined. The discovery window is mainly a communication period that occurs intermittently for the device to perform service notification and search, and arrives at a predetermined cycle. A set of devices sharing the discovery window is called a NAN cluster. A device operating as a master transmits a discovery beacon for recognizing the NAN cluster to another device that does not yet belong to the NAN cluster. The device operating as the master transmits a synchronization beacon for each device to synchronize with the discovery window. In the embodiment, the terminal device 100 may operate as a master, or the printing device 200 may operate as a master.

Each device constituting the NAN cluster can check a service provided by each device by transmitting and receiving a signal in the discovery window. Specifically, in the discovery window, a signal implemented by a frame of a format called a service discovery frame is transmitted.

A device constituting the NAN cluster can establish a data link capable of intercommunicating with another device constituting the NAN cluster regardless of a DW period. That is, the NAN connection can be established between devices constituting the NAN cluster. In the NAN standard, the above-described data link is called a NAN data link. Hereinafter, a flow until the terminal device 100 and the printing device 200 perform the NAN connection in the embodiment will be described.

First, the terminal device 100 and the printing device 200 share the discovery window. In order to share the discovery window, either the terminal device 100 or the printing device 200 operates as a master. For example, when the terminal device 100 operates as a master, the connection processing unit 151 of the terminal device 100 performs processing of transmitting a discovery beacon and a synchronization beacon from the terminal device 100.

When the terminal device 100 and the printing device 200 share the discovery window, the printing device 200 waits for an inquiry about the service to be broadcast. Then, the connection processing unit 151 of the terminal device 100 performs communication using the discovery window in order to search for the printing device 200 that provides the service capable of performing the printing instructed by the printing operation. Specifically, the connection processing unit 151 broadcasts the inquiry about the service by transmitting a signal using the discovery window defined in the NAN standard. That is, the connection processing unit 151 broadcasts a message for making an inquiry to all other devices constituting the NAN cluster. The message is a message using the service discovery frame. On the other hand, the connection processing unit 241 of the printing device 200, which receives the broadcast of the inquiry and can provide a service capable of performing the printing instructed by the printing operation, responds to the inquiry by transmitting a signal using the discovery window defined by the NAN standard. Accordingly, the terminal device 100 can specify the printing device 200 that can perform the printing instructed by the printing operation. Thereafter, the connection processing unit 151 of the terminal device 100 and the connection processing unit 241 of the printing device 200 capable of performing the printing instructed by the printing operation execute processing of establishing the NAN data link according to a connection procedure conforming to the NAN standard. Accordingly, the NAN connection is established.

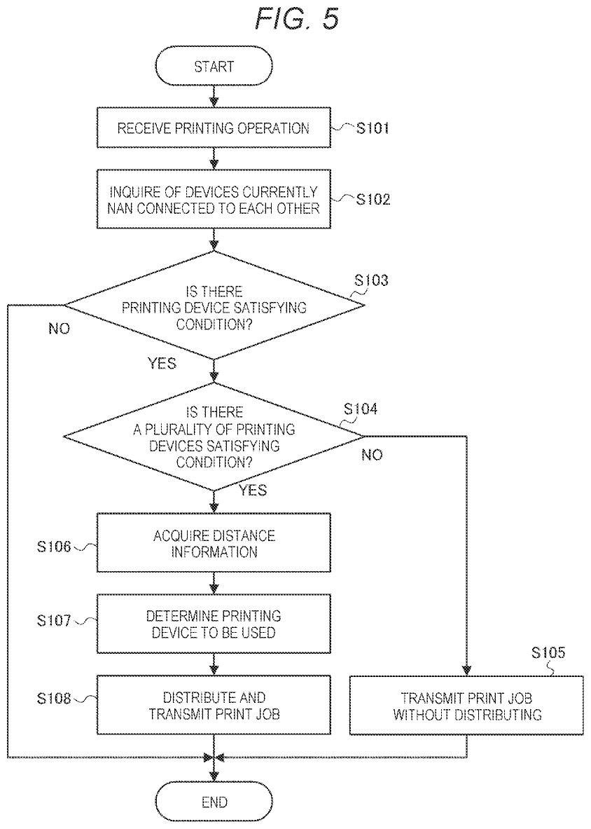

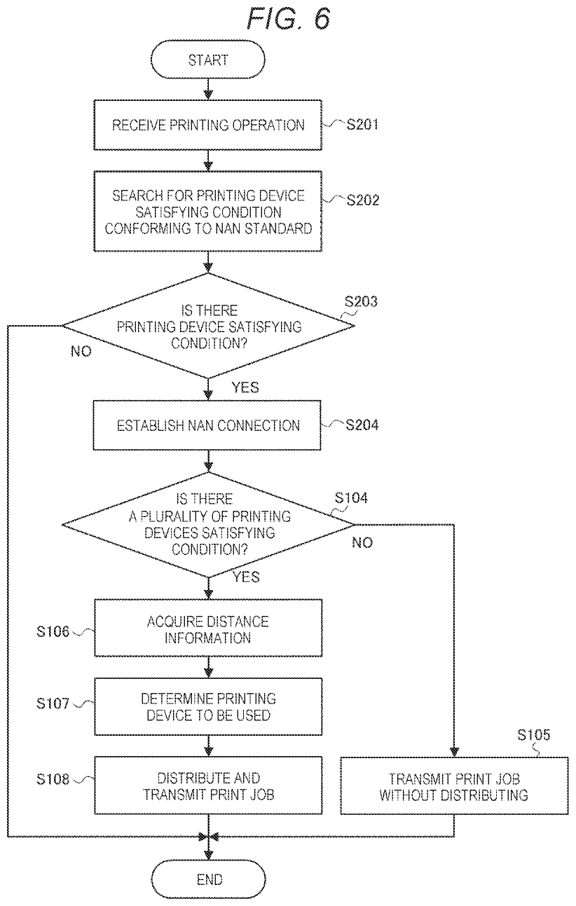

Next, an operation flow of the terminal device 100 according to the embodiment will be described. FIG. 5 is a flowchart showing an example of the operation flow of the terminal device 100 when only the printing device 200 that has already been NAN connected to the terminal device 100 at the time of the printing operation of the user is set as a candidate of a transmission destination of a print job. FIG. 6 is a flowchart showing an example of the operation flow of the terminal device 100 when a new printing device 200 to be NAN connected to the terminal device 100 is searched for after the printing operation of the user. The terminal device 100 may operate according to the flowchart shown in FIG. 5 or may operate according to the flowchart shown in FIG. 6.

First, the operation flow when the operation is performed according to the flowchart in FIG. 5 will be described.

In step S101, the input reception unit 153 receives a printing operation performed by the user via the operation unit 140.

Next, in step S102, the printing control unit 155 inquires of devices that have already been NAN connected to each other about a service using the NAN connection. The printing control unit 155 searches for the printing device 200 capable of performing printing instructed by the printing operation from among the NAN connected devices. When there is the printing device 200 satisfying conditions, that is, when there is the printing device 200 capable of performing the printing instructed by the printing operation (YES in step S103), the processing proceeds to step S104. When there is no printing device 200 capable of performing the printing instructed by the printing operation (NO in step S103), the processing ends. At this time, the display control unit 154 may display on the display unit 130 that printing cannot be performed.

In step S104, the printing control unit 155 determines whether there is the plurality of printing devices 200 that satisfy the conditions. When there is no plurality of printing devices 200 that satisfy the conditions, that is, when there is only one printing device 200 that satisfies the conditions (NO in step S104), the processing proceeds to step S105, and when there is the plurality of printing devices 200 that satisfy the conditions (YES in step S104), the processing proceeds to step S106.

In step S105, the printing control unit 155 generates a print job for performing printing in one printing device 200 satisfying the conditions, and transmits the generated print job to the one printing device 200. That is, in this case, the printing control unit 155 transmits the print job without distributing the print job. Accordingly, the one printing device 200 that receives the print job performs all the printing instructed by the printing operation. Thereafter, the processing ends.

When the processing proceeds to step S106, the distance information acquisition unit 152 acquires a distance between the terminal device 100 and each printing device 200 satisfying the conditions. The distance information acquisition unit 152 may acquire the distance between the terminal device 100 and any printing device 200 regardless of whether the processing proceeds to step S106.

After step S106, in step S107, the printing control unit 155 determines a printing device 200 to be used from among the printing devices 200 satisfying the conditions. At this time, the display control unit 154 controls the display unit 130 to display a user interface screen including a list of the printing devices 200 satisfying the conditions, that is, a list of candidates of the printing devices 200 as the transmission destinations of the print job. FIG. 7 is a schematic diagram showing an example of a user interface screen 90 displayed by the display control unit 154. As shown in FIG. 7, the display control unit 154 displays a distance between the terminal device 100 and each candidate of the printing device 200 as the transmission destination of the print job. As shown in FIG. 7, the display control unit 154 may display identification information (printer name) of each printing device 200. Therefore, the printing control unit 155 may inquire of the printing devices 200 that are NAN connected to each other about the identification information of the printing devices 200. The user interface screen 90 shown in FIG. 7 also includes buttons 91 and 92 for selecting whether to determine the printing device 200 as the transmission destination by manual selection or to determine the printing device 200 as the transmission destination by automatic selection.

When the user operates the button 91, the printing control unit 155 determines the printing device 200 as the transmission destination of the print job by the automatic selection. On the other hand, when the user operates the button 92, the printing control unit 155 sets the printing device 200 designated by the user as the printing device 200 as the transmission destination of the print job. FIG. 8 shows an example of a user interface screen 90a when the manual selection is performed. In the example shown in FIG. 8, three printing devices 200 whose identification information is the “printer A”, “printer B”, and “printer C” are selected by the user. On the other hand, when the automatic selection is performed, the printing control unit 155 selects, based on the distance acquired in step S106, the printing device 200 to which the print job is to be transmitted.

Next, in step S108, the printing control unit 155 generates a plurality of print jobs for performing printing in the plurality of printing devices 200 selected in step S107, and transmits the generated print jobs to the printing devices 200 that is in charge of the print jobs. That is, in this case, the printing control unit 155 distributes and transmits the print jobs. Then, each printing device 200 that receives a print job performs printing based on the print job.

Next, the flow when the operation is performed according to the flowchart in FIG. 6 will be described. In this case, step S201 to step S204 are performed instead of step S101 to step S103 shown in the flowchart in FIG. 5. Hereinafter, differences from the flowchart shown in FIG. 5 will be described, and the overlapping description will be appropriately omitted.

In step S201, the input reception unit 153 receives a printing operation performed by the user via the operation unit 140.

Next, in step S202, the connection processing unit 151 searches for, by broadcasting an inquiry about a service conforming to the NAN standard, the printing device 200 capable of providing the service for implementing printing instructed by the printing operation. That is, the connection processing unit 151 performs communication using a discovery window, and searches for the printing device 200 that satisfies conditions. When the printing device 200 that satisfies the conditions is found (YES in step S203), the processing proceeds to step S204, and when the printing device 200 that satisfies the conditions is not found (NO in step S203), the processing ends. At this time, the display control unit 154 may display on the display unit 130 that printing cannot be performed. In step S204, the connection processing unit 151 establishes the NAN connection with the printing device 200 that satisfies the conditions. After step S204, the processing proceeds to step S104. The subsequent processing is the same as the flowchart shown in FIG. 5.

The embodiment is described above. According to the embodiment, the printing can be performed by the plurality of printing devices 200 for which the NAN connection is established. Accordingly, it is possible to shorten a time until the printing is completed as compared with the case where the printing is performed by one printing device 200. That is, according to the embodiment, it is possible to improve efficiency of a work for printing.

Next, a modification of the above-described embodiment will be described. In the above-described embodiment, the terminal device 100 and the printing device 200 use only communication conforming to the NAN standard for transmission and reception of a print job. Alternatively, the terminal device 100 and the printing device 200 may have functions of transmitting and receiving the print job through communication via an access point.

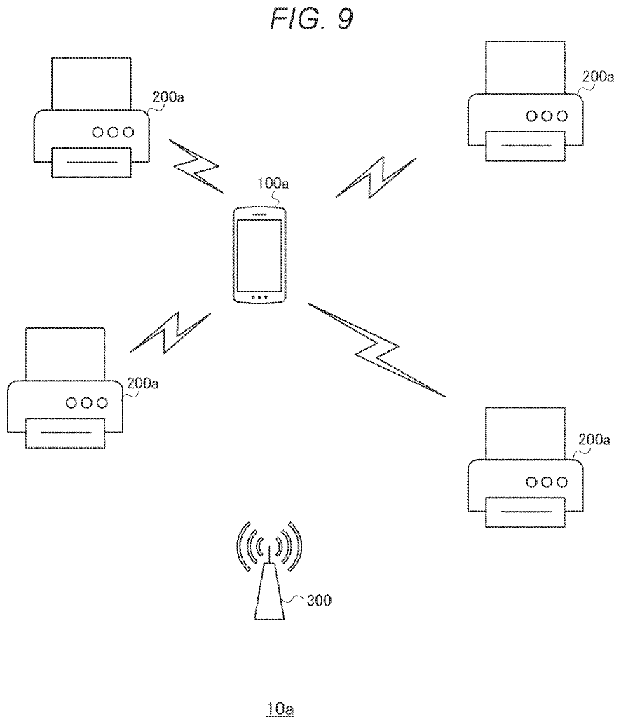

FIG. 9 is a schematic diagram showing an example of a configuration of a printing system 10a according to the modification of the embodiment. The printing system 10a includes a terminal device 100a, one or more printing devices 200a, and an access point 300. The access point 300 is an access point of a wireless local area network (LAN). Specifically, the wireless LAN may be a Wi-Fi (registered trademark) network.

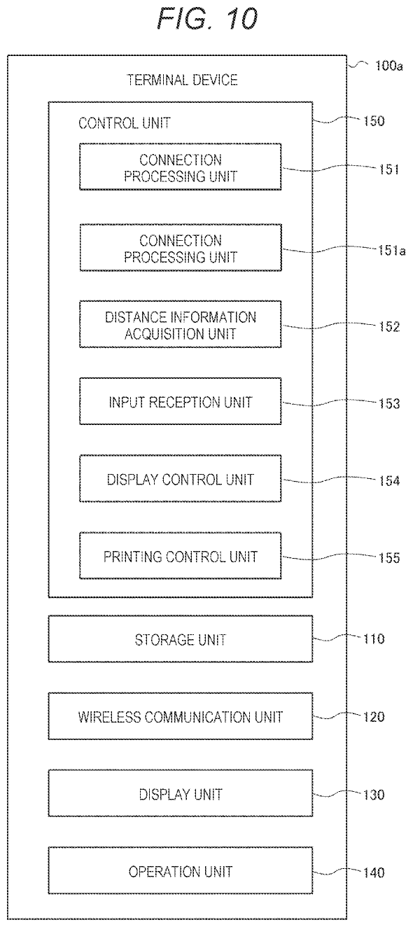

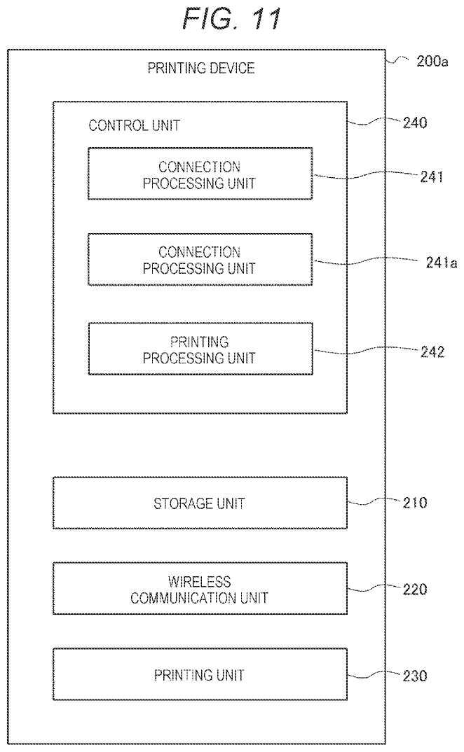

FIG. 10 is a block diagram showing an example of a configuration of the terminal device 100a according to the modification. FIG. 11 is a block diagram showing an example of a configuration of the printing device 200a according to the modification. As shown in FIG. 10, the terminal device 100a is different from the terminal device 100 shown in FIG. 2 in that the terminal device 100a further includes a connection processing unit 151a. As shown in FIG. 11, the printing device 200a is different from the printing device 200 shown in FIG. 4 in that the printing device 200a further includes a connection processing unit 241a. Hereinafter, configurations and processing different from those of the above-described embodiment will be described, and the overlapping description will be appropriately omitted.

The connection processing unit 151a establishes wireless communication connection in a wireless communication method different from the wireless communication method in the NAN connection. For example, the connection processing unit 151a establishes infrastructure mode wireless communication connection defined by the Wi-Fi (registered trademark) standard. Accordingly, the connection processing unit 151a establishes wireless communication connection with the printing device 200a via the access point 300. In particular, in order to implement printing using the plurality of printing devices 200a, the connection processing unit 151a establishes wireless communication connection with the plurality of printing devices 200a via the access point 300. Specifically, the connection processing unit 151a establishes the wireless communication connection via the access point 300 using a service set identifier (SSID) and a password of the access point 300. Similarly, the connection processing unit 241a also establishes the wireless communication connection in the wireless communication method different from the wireless communication method in the NAN connection. That is, the connection processing unit 241a establishes the wireless communication connection with the terminal device 100a via the access point 300. Specifically, the connection processing unit 241a establishes the wireless communication connection via the access point 300 using the SSID and the password of the access point 300.

In the modification, the printing control unit 155 of the terminal device 100a performs control to distribute and transmit print jobs to the plurality of printing devices 200a using the NAN connection or the wireless communication connection via the access point 300. Accordingly, it is possible to improve convenience in distributed printing as compared with a configuration in which only one of the NAN connection and the wireless communication connection via the access point 300 can be established. When the distributed printing is performed, the printing control unit 155 may perform control such that the print jobs are distributed and transmitted only to the plurality of printing devices 200a for which the NAN connection is established, or may perform control such that the print jobs are distributed and transmitted only to the plurality of printing devices 200a for which the wireless communication connection via the access point 300 is established. The printing control unit 155 may perform control to distribute and transmit the print jobs to the one or more printing devices 200a for which the NAN connection is established and one or more other printing devices 200a for which the wireless communication connection via the access point 300 is established.

When the wireless communication connection with the plurality of printing devices 200a via the access point 300 is established, the printing control unit 155 may perform control to distribute and transmit the print jobs to the plurality of printing devices 200a using the wireless communication connection. In other words, the printing control unit 155 may perform control to distribute and transmit the print jobs to the plurality of printing devices 200a using the NAN connection only when the wireless communication connection with the printing devices 200a via the access point 300 cannot be established. As described above, the printing control unit 155 may prioritize the transmission of the print jobs by the wireless communication connection via the access point 300 than the transmission of the print jobs by the NAN connection. Accordingly, it is possible to prevent complication of processing due to the transmission of the print jobs by the NAN connection with a large number of the printing devices 200.

Also when the print jobs are transmitted by the wireless communication connection via the access point 300, automatic selection or manual selection is performed similarly as in the above-described embodiment. In this case, too, the distance information acquisition unit 152 may acquire a distance measured conforming to the NAN standard or may acquire a distance measured according to another technique. The distance information acquisition unit 152 may acquire a distance input by the user via the operation unit 140.

Although the embodiment and the modification thereof are described above, the present disclosure is not limited to the embodiment and the modifications thereof, and can be appropriately modified without departing from the gist of the present disclosure.

In the example described above, the program includes an instruction group (or a software code) for causing the computer to perform one or more functions described in the embodiment when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or other memory technologies, a CD-ROM, a digital versatile disk (DVD), a Blu-ray (registered trademark) disk or other optical disk storages, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

A part or all of the embodiment described above may be described as in the following appendixes, but are not limited thereto.

### Appendix 1

A terminal device including:
a first connection processing unit configured to search for a plurality of printing devices conforming to a neighbor awareness network (NAN) standard, and to establish first wireless communication connection with the plurality of printing devices conforming to the NAN standard; and
a printing control unit configured to perform control to distribute and transmit a print job to the plurality of printing devices using the first wireless communication connection.

### Appendix 2

The terminal device according to appendix 1, in which
the printing control unit is configured to acquire, from the plurality of printing devices for which the first wireless communication connection is established, information on a service of the printing device using the first wireless communication connection, and select, based on the acquired information, the printing device to which the print job is to be transmitted.

### Appendix 3

The terminal device according to appendix 1, in which
the first connection processing unit is configured to search for the plurality of printing devices capable of providing a service satisfying a specific condition by broadcasting an inquiry about a service conforming to the NAN standard.

### Appendix 4

The terminal device according to any one of appendixes 1 to 3, further including:
a distance information acquisition unit configured to acquire, for each of the plurality of printing devices, distance information indicating a distance between the terminal device and the printing device measured conforming to the NAN standard; and
a display control unit configured to perform control to display the distance information of each of the plurality of printing devices.

### Appendix 5

The terminal device according to any one of appendixes 1 to 4, further including:
a distance information acquisition unit configured to acquire, for each of the plurality of printing devices, distance information indicating a distance between the terminal device and the printing device measured conforming to the NAN standard, in which
the printing control unit is configured to select, based on the distance information, the printing device to which the print job is to be transmitted.

### Appendix 6

The terminal device according to any one of appendixes 1 to 5, further including:
a second connection processing unit configured to establish second wireless communication connection with the plurality of printing devices via an access point, in which
the printing control unit is configured to perform control to distribute and transmit the print job to the plurality of printing devices using the first wireless communication connection or the second wireless communication connection.

### Appendix 7

The terminal device according to appendix 6, in which
when the second wireless communication connection with the plurality of printing devices is established, the printing control unit performs control to distribute and transmit the print job to the plurality of printing devices using the second wireless communication connection.

### Appendix 8

A method for controlling a terminal device, the method including:
searching for a plurality of printing devices conforming to a NAN standard, and establishing first wireless communication connection with the plurality of printing devices conforming to the NAN standard; and
performing control to distribute and transmit a print job to the plurality of printing devices using the first wireless communication connection.

### Appendix 9

A non-transitory computer-readable storage medium storing a program, the program causing a computer to:
execute first connection processing of searching for a plurality of printing devices conforming to a NAN standard, and establishing first wireless communication connection with the plurality of printing devices conforming to the NAN standard; and
execute printing control of performing control to distribute and transmit a print job to the plurality of printing devices using the first wireless communication connection.

What is claimed is:

1. A terminal device comprising:
a first connection processor configured to search for a plurality of printing devices conforming to a neighbor awareness network (NAN) standard, and to establish first wireless communication connection with the plurality of printing devices conforming to the NAN standard; and
a printing controller configured to perform control to distribute and transmit a print job to the plurality of printing devices using the first wireless communication connection.

2. The terminal device according to claim 1, wherein
the printing controller is configured to acquire, from the plurality of printing devices for which the first wireless communication connection is established, information on a service of the printing device using the first wireless communication connection, and select, based on the acquired information, the printing device to which the print job is to be transmitted.

3. The terminal device according to claim 1, wherein
the first connection processor is configured to search for the plurality of printing devices capable of providing a service satisfying a specific condition by broadcasting an inquiry about a service conforming to the NAN standard.

4. The terminal device according to claim 1, further comprising:
a distance information acquisition unit configured to acquire, for each of the plurality of printing devices, distance information indicating a distance between the terminal device and the printing device measured conforming to the NAN standard; and
a display controller configured to perform control to display the distance information of each of the plurality of printing devices.

5. The terminal device according to claim 1, further comprising:
a distance information acquisition unit configured to acquire, for each of the plurality of printing devices, distance information indicating a distance between the terminal device and the printing device measured conforming to the NAN standard, wherein
the printing controller is configured to select, based on the distance information, the printing device to which the print job is to be transmitted.

6. The terminal device according to claim 1, further comprising:
a second connection processor configured to establish second wireless communication connection with the plurality of printing devices via an access point, wherein
the printing controller is configured to perform control to distribute and transmit the print job to the plurality of printing devices using the first wireless communication connection or the second wireless communication connection.

7. The terminal device according to claim 6, wherein
when the second wireless communication connection with the plurality of printing devices is established, the printing controller performs control to distribute and transmit the print job to the plurality of printing devices using the second wireless communication connection.

8. A method for controlling a terminal device, the method comprising:
searching for a plurality of printing devices conforming to a NAN standard, and establishing first wireless communication connection with the plurality of printing devices conforming to the NAN standard; and
performing control to distribute and transmit a print job to the plurality of printing devices using the first wireless communication connection.

9. A non-transitory computer-readable storage medium storing a program, the program causing a computer to:
execute first connection processing of searching for a plurality of printing devices conforming to a NAN standard, and establishing first wireless communication connection with the plurality of printing devices conforming to the NAN standard; and
execute printing control of performing control to distribute and transmit a print job to the plurality of printing devices using the first wireless communication connection.
